(19) United States
(12) Patent Application Publication
(10) Pub. No.: US 2015/0213414 A1
(43) Pub. Date: Jul. 30, 2015

(54) WAIT TIME NOTIFICATION SYSTEM AND METHODS THEREOF

(71) Applicants: Andrew Zuckerman, Livingston, NJ (US); David Zuckerman, Livingston, NJ (US)

(72) Inventors: Andrew Zuckerman, Livingston, NJ (US); David Zuckerman, Livingston, NJ (US)

(21) Appl. No.: 14/598,271

(22) Filed: Jan. 16, 2015

Related U.S. Application Data
(60) Provisional application No. 61/933,728, filed on Jan. 30, 2014.

(51) Int. Cl. G06Q 10/10

(52) U.S. Cl. CPC G06Q 10/1095

(57) ABSTRACT

A method for optimizing customer scheduling, the method may comprise receiving a request to make an appointment for the customer, scheduling an appointment time for the customer, and recording the appointment time; recording an arrival time for the customer when the customer arrives for their appointment and calculating the amount of time the customer is tardy based on the appointment time; associating the amount of time the customer is tardy with the user account for the customer and saving it in memory as tardiness data; generating an anticipated amount of time the customer will arrive after their appointment time for a next appointment based on the tardiness data; receiving a request to make a second appointment for the customer, and notifying a user of the anticipated amount of time the customer will arrive after their appointment time; and scheduling the second appointment time for the customer and recording the appointment time.

### CROSS-REFERENCE TO RELATED APPLICATIONS

The present application claims priority to U.S. Provisional Patent application Ser. No. 61/933,728 entitled “WAIT TIME NOTIFICATION SYSTEM AND METHODS THEREOF,” filed Jan. 30, 2014, the disclosure of which is incorporated herein by reference in its entirety as if fully set forth herein.

### BACKGROUND

1. Field of the Invention

Embodiments of the present invention are generally related to a wait time notification system and methods thereof. More specifically, embodiments of the present invention may include monitoring healthcare provider wait times, notifying patients of the monitored wait times, providing patients the option to modify an appointment based on the monitored wait times, and/or providing alternative activity options for the patients during the waiting process.

### SUMMARY

Embodiments of the present disclosure generally relate to a wait time notification system and methods thereof. In one embodiment of the present disclosure, a method is provided that may comprise receiving a request to create a customer account for a customer; creating the customer account for the customer; receiving a request to make an appointment for the customer, scheduling an appointment time for the customer, and recording the appointment time; recording an arrival time for the customer when the customer arrives for their appointment and calculating the amount of time the customer is tardy based on the appointment time; associating the amount of time the customer is tardy with the user account for the customer and saving it in memory as tardiness data; generating an anticipated amount of time the customer will arrive after their appointment time for a next appointment based on the tardiness data; receiving a request to make a second appointment for the customer, and notifying a user of the anticipated amount of time the customer will arrive after their appointment time; and scheduling the second appointment time for the customer and recording the appointment time.

### BRIEF DESCRIPTION OF THE DRAWINGS

So the manner in which the above-recited features of the present invention can be understood in detail, a more particular description of embodiments of the present invention, briefly summarized above, may be had by reference to embodiments, which are illustrated in the appended drawings. It is to be noted, however, the appended drawings illustrate only typical embodiments of embodiments encompassed within the scope of the present invention, and, therefore, are not to be considered limiting, for the present invention may admit to other equally effective embodiments, wherein:

FIG. 1 depicts a system level network diagram of an exemplary system in accordance with one embodiment of the present invention;

FIG. 2 depicts an exemplary client computer capable of being used with the system depicted in FIG. 1, in accordance with embodiments of the present invention; and

FIG. 3 depicts a flowchart of a method of monitoring wait times in accordance with embodiments of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

Embodiments of the present invention are generally related to a wait time notification system and methods thereof. More specifically, embodiments of the present invention may include monitoring healthcare provider wait times, notifying patients of the monitored wait times, providing patients the option to modify an appointment based on the monitored wait times, and/or providing alternative activity options for the patients during the waiting process. In accordance with certain embodiments of the present invention, methods disclosed herein may occur in “real-time.” Real-time is utilized herein as meaning near-instantaneous, subject to minor delays caused by network transmission and computer processing functions, and able to support various input and output data streams.

As used herein, the terms “patient” and “patients” may refer to one or more individuals seeking medical attention and/or treatment. As used herein, the term “healthcare provider” may refer to an individual or institution that provides preventative, curative, promotional, and/or rehabilitative health care services to individuals, families, or communities. Healthcare providers may include an individual or institution in the field of medicine, nursing, dentistry, optometry, pharmacy, allied health professions, and/or the like. For example, a “healthcare provider” may refer to a medical doctor, a nurse, a nurse practitioner, a physician's assistant, a dentist, a dental hygienist, a dental assistant, a psychologist, a psychiatrist, a counselor, a physical therapist, an athletic trainer, a healthcare technician, a chiropractor, a dietitian, a health educator, a hospital administrator, a home health aide, a licensed practical nurse, an ophthalmologist, an optician, an optometrist, a pharmacist, a podiatrist, a respiratory therapist, a veterinarian, a hospital, a medical office, an emergency room, an urgent care facility, a clinic, and/or the like. Although systems and methods are described herein for use within the healthcare industry, it is contemplated by and within embodiments of the present invention that systems and methods presented herein may be applied to alternative industries requiring clients, consumers, customers, business partners, and/or the like to wait for products, services, and/or the like.

Patients often wait significant amounts of time to be seen or evaluated by a medical professional when visiting a healthcare provider. Even in cases where appointments are scheduled in advance at a specified time and the patients arrive at or before their appointment, patients are often expected to wait long after their scheduled appointments to be seen. In a typical scenario, a patient may show up 15 minutes before a scheduled appointment, sign-into a log book or guest book to be seen, and then wait for more than 45 minutes after their scheduled wait time to see a doctor. In many offices, the typical wait times can average over an hour past scheduled appointment times. Waiting for an extended period of time may create anxiety for a patient, worsen a medical condition, and generally leave a patient frustrated and/or dissatisfied.

In some instances, these wait times may be caused by an unexpected emergency medical situation that a doctor must attend to. In most instances, however, long wait times at healthcare provider facilities are caused by overbooking patients to allow for “no-shows”, increasing revenue, and sometimes encouraging unforeseen non-emergency procedures. This model of operating providing healthcare often does produce increased revenue, but the patients often leave their appointments in frustration, aggravation, and general dissatisfaction with the experience due to the long wait times. In many instances, appointment times are considered as merely suggestions and patient satisfaction is ignored or given little consideration by healthcare providers, who may instead focus only on the volume of patients seen as a means of producing revenue. Systems and methods of the present invention are generally adapted to increase patient satisfaction and increasing revenue for a healthcare provider by monitoring wait times and notifying patients of current wait times, and/or the like. By notifying patients of wait times, the patients may feel more valued, may wish to reschedule an appointment to maximize use of their time, and may generally be more satisfied with interactions with a specific healthcare provider. By increasing patient satisfaction rates, healthcare providers can distinguish themselves from competitors and increase revenue. In some instances a healthcare provider may be able to advertise the shortest wait times or the highest patient satisfaction rating in a geographic area, which may attract more patients and increase revenue accordingly.

In exemplary embodiments, a system and method may be adapted to provide patients with current wait times to be seen at a healthcare provider. In some embodiments, a patient may be presented the option to reschedule an appointment if the wait time is over a predetermined threshold. In some embodiments, a patient may be provided with options for alternative activities to complete while waiting to be seen by a medical professional. In some embodiments, analysis may be performed on data stored within a system and potential areas for improvement may be identified.

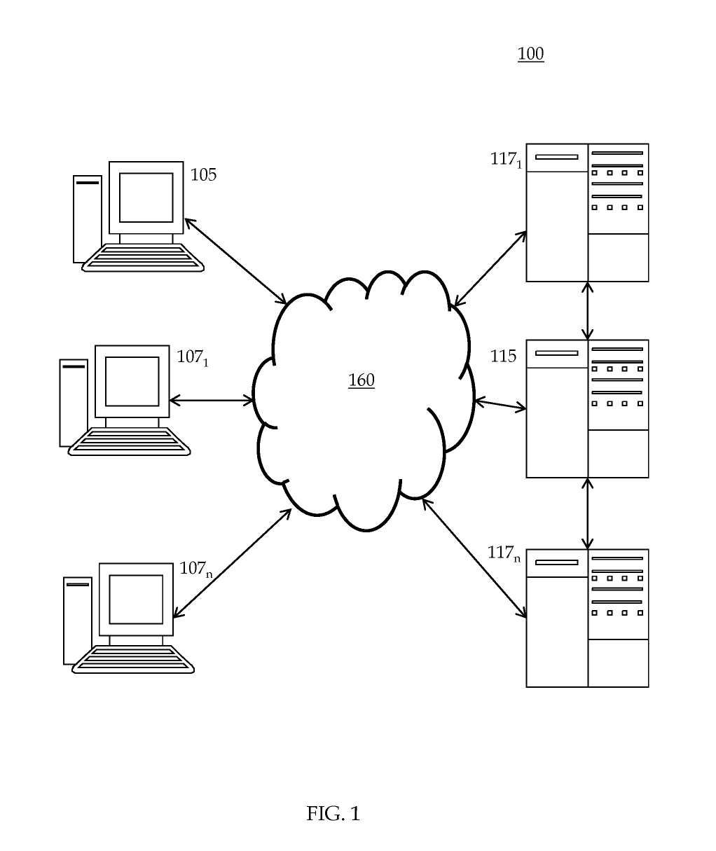

FIG. 1 depicts a system-level network diagram of a wait time notification system in accordance with one embodiment of the present invention. The system 100 generally comprises at least a first client 105 and secondary clients 107₁ and 107n, each in communication with an administrator, generally hosting a central server 115, through a network 160. Methods in accordance with one or more embodiments of the present invention take place over the network 160, which may comprise a global computer network, for example, the Internet.

Although FIG. 1 depicts two secondary clients 107₁ and 107n, it should be appreciated that “n” represents any number of clients feasible in accordance with embodiments of the present disclosure. For ease of reference, as used herein, the term “client” may refer to any one or all of the clients, 105, 107₁, and 107ₙ within the system 100. Likewise, although FIG. 1 explicitly depicts only one first client 105, there may be more than one first client 105 in accordance with certain embodiments of the present invention. That is, in certain embodiments, multiple users may perform the same or similar functions as the first client 105. As understood by embodiments of the present invention, a user may include any person or entity capable of participating in the system and methods disclosed herein.

The first client 105 may generally comprise a patient or an individual seeking medical treatment or evaluation, the patient having been scheduled and/or waiting for attention from a medical professional at a healthcare provider. The secondary clients 107 may generally comprise one or more healthcare providers. In a basic exemplary embodiment, within the system 100, the first client 105, and/or any of the secondary clients 107, may be capable of transmitting data to and from an administrator using a communication device. The communication device in the context of the present application may include, but is not limited to, a personal computer, a portable computer, a handheld computer, a netbook, a cellular phone, a smart phone, a mobile phone, a digital tablet, a laptop computer, tablet computer, a smart TV, a device configured to connect to the Internet, an Internet appliance, an Apple iPhone, iPad, or iPod, an Android device, a Blackberry device, a Personal Data Assistant (PDA) or the like, or may generally include a general purpose computer.

The administrator may generally comprise a server 115, which may further host an accessible data portal. In alternative embodiments, the server 115 may be located on a third party location (e.g., a server farm, or cloud), or at a location of a healthcare provider. The accessible data portal, which may be accessible to the administrator, the first client 105, and/or any of the secondary clients 107, communicates with each user through the network 160. The accessible data portal may comprise any number of security measures to provide a reasonably secure system, suitable for embodiments of the present invention. The accessible data portal may further comprise a graphical user interface (GUI) through which any of the administrator, first client 105, or secondary clients 107 may access the server 115.

Methods in accordance with embodiments of the present invention may take place over the network 160, which may comprise a global computer network, for example, the internet. The communications functions described herein can be accomplished using any kind of wired and/or wireless computing network or communications means capable of transmitting data or signals, such as a wireless and/or wired computing network allowing communication via, for example, an 802.11 wireless LAN (“WLAN”) protocols, “Wi-Fi” protocols, Bluetooh protocols, 60 Ghz Protocols (“WirlessHD” and “WiGig”), Wireless Home Automation protocols (“Z-Wave” and “Zigbee”), cellular data protocol (e.g., EDGE, CDMA, CDMA2000, TD-SCDMA, WCDMA, UMTS, HSDPA, EVDO, TDMA, FDMA, GSM, LTE, HSPA+, WiMAX, OFDMA), and/or the like. Suitable examples include a packet-switched network, a local area network (LAN), wide area network (WAN), virtual private network (VPN), or any other means of transferring data. The network 160 may be a partial or full deployment of most any communication/computer network or link, including any of, any multiple of, any combination of or any combination of multiples of a public or private, terrestrial wireless or satellite, and wireline networks or links. A single network 160 or multiple networks (not shown) that are communicatively coupled to one another can be used. It is contemplated that multiple networks of varying types can be connected together and utilized to facilitate the communications contemplated by the systems and elements described in this disclosure.

As used herein, the term “computer” may generally refer to any device that is capable of processing a signal or other information. Examples of computers include, without limitation, a personal computer, a portable computer, a handheld computer, a cellular phone, a smart phone, a digital tablet, a laptop computer, a netbook, a smart TV, a device configured to connect to the internet, an Internet appliance, a Personal Data Assistant (PDA), an application-specific integrated circuit (ASIC), a programmable logic array (PLA), a microcontroller, a digital logic controller, a digital signal processor (DSP), or the like, or may generally include a general purpose computer. A computer may include software in the form of programmable code, micro code, and or firmware or other hardware embedded logic and may include multiple processors which operate in parallel. The processing performed by a computer may be distributed among multiple separate devices, and the term computer encompasses all such devices when configured to perform in accordance with the disclosed embodiments.

The system may also comprise secondary servers 117₁ and 117ₙ. Although two secondary servers 117₁ and 117ₙ are depicted in FIG. 1, it should be appreciated that “n” represents any number of servers feasible in accordance with embodiments of the present disclosure. For ease of reference, as used herein, the term “server” may refer to any one or all of the servers, 115, 117₁, and 117ₙ within the system 100. That is, in certain embodiments, multiple servers may perform the same or similar functions.

The servers 115, 117 may also comprise one or more databases or other sortable data storage memory to enable the system and methods disclosed herein. In many embodiments, the database may be any commercially available data storage database suitable for embodiments of the present disclosure. For example, in one embodiment, the database comprises at least one or more database management systems, such as any of an Oracle, DB2, Microsoft Access, Microsoft SQL Server, Postgres, MySQL, 4th Dimension, FileMaker, Alpha Five Database Management System, or the like. Often contained within the database is a plurality of data sets, each comprising specific data. A first data set may correlate to a first client 105, wherein a plurality of client-specific data is stored. The database may also include any number of subsequent data sets representing N clients, wherein N represents any number of clients practical for operation of embodiments of the present disclosure. In accordance with one embodiment of the present disclosure, any of the servers or clients may comprise a general purpose computer.

In accordance with one embodiment of the present invention, any of the administrator or users may comprise a general purpose computer. As appreciated by embodiments of the present invention, more practical devices, such as mobile devices, mobile telephones, or the like, are likely to be utilized than a general computer for embodiments of the present invention. However, it is also appreciated there is a significant similarity in core components between a mobile device and a general computer. In some embodiments, a number of alerts and/or communications generated by the system 100 may be transmitted to the clients 105, 107 via text message, email, picture message, video message, instant message, social media notification, and/or the like.

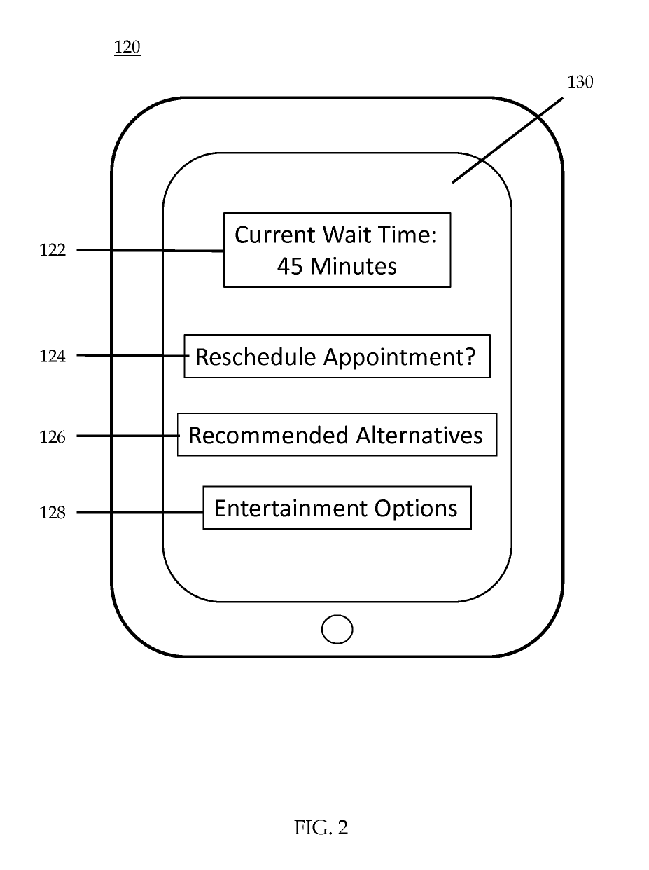

FIG. 2 depicts an exemplary client computer 120 capable of being used with the system 100 depicted in FIG. 1, in accordance with embodiments of the present invention. The client computer 120 may generally comprise a mobile device, such as a smartphone, tablet computer, netbook, laptop, or the like, or any computing device in accordance with the present disclosure. The client computer 120 may comprise a display 130 adapted to display a wait time indicator 122, a scheduling interface 124, an alternative activity interface 126, and/or an entertainment interface 128 and/or the like. In exemplary embodiments, the client computer 120 may be adapted to communicatively couple with the system 100 depicted in FIG. 1. The client computer 120 may be accessed by one or more patients, healthcare providers, administrators, and/or the like. The client computer 120 may comprise common computer components, such as a processor, memory, a power source, a transmit/receive unit, a data input, a data output, and/or the like. The client computer 120 may be adapted to receive, transmit, process, and store data related to healthcare provider wait times and/or the like. The client computer 120 may comprise a user's personal mobile communications device and/or a device provided by a healthcare provider with access restricted to patients currently waiting to be seen by a healthcare professional.

In exemplary embodiments, a current wait time indicator 122 may be adapted to display a current, recent, anticipated, and/or real-time wait time for patients to be seen by a medical professional, or the like. The wait times comprise wait times of patients previously seen that day, the wait times measured and/or input by medical staff, doctors, patients, and/or the like. In some embodiments, the wait times may be calculated by the system based on the number of patients scheduled, the types of appointments scheduled, a number of medical professionals available, and/or the like. In some embodiments, wait times may be automatically updated when a patient is seen by the doctor, or the like. For example, a doctor or medical professional may scan a bar code associated with a room and/or a patient upon entering a room and seeing a patient. The wait time for all other patients may then be updated accordingly.

In some embodiments, the system may be adapted to receive wait times for anyone with knowledge of actual and/or measured wait times. For example, patients may enter wait times via a smartphone, and/or the like. In some embodiments, the system may include a counter component adapted to measure wait time. For example, the system may comprise a timer that is manually activated when the user begins waiting, or a timer that automatically starts running at a patient's appointment time. In some embodiments, a patient may be provided with the option to start a timer when a waiting time begins and stop a timer when the user is seen by a doctor, and the waiting time measured by the timer may be stored via the system, displayed, and/or sent to other users of the system. The system may be adapted to allow wait times to be manually adjusted. For example, if a particular doctor will be unavailable for 30 minutes, a user of the system may be provided access to manually input an additional 30 minutes of wait time via system. Upon receipt of a wait time manual adjustment, the system may automatically adjust all appointments for that doctor, or all scheduled appointments for a particular facility, to reflect an additional 30 minutes of wait time, or the like.

In some embodiments, the wait time displayed may be divided into segments. For example, a first segment may comprise wait times for availability of a patient to be placed in an evaluation room, a second segment may comprise wait times to be seen by a nurse, a third segment may comprise wait times to be seen by a doctor, and a fourth segment may comprise an average appointment time. In some embodiments, the wait time may comprise an estimated or measured time until the patient is to be seen by a doctor. The current wait time indictor 122 may also be adapted to display an expected time of departure from the healthcare provider facility. To measure time in each segment, in exemplary embodiments, bar codes, RFID chips, or other identifying members may be placed in a room and/or part of a wearable item for the patient, such as a bracelet. In some embodiments, when the patient enters a room, when a nurse sees the patent, and/or when the doctor sees the patient, the bar code, RFID chip, or other identifying member on the examination room or worn by the patient may be scanned and/or read by the doctor, nurse, or the like. After scanning the system may dynamically update the wait time data presented to users of the system.

In exemplary embodiments, the system may comprise a database comprising average appointment times for standard appointment types. For example, an average annual physical may take an hour, an average skin screening may take 30 minutes, an average infant or toddler vaccination may take 25 minutes, an average cold evaluation may take 35 minutes, and/or the like. When scheduling an appointment with the doctor's office the patient and/or the doctor's office may indicate to the system a type of appointment. If the type of appointment matches one of a set of standard appointment types, the system may be adapted to access an average time that each appointment takes and update expected wait times accordingly. As such, the system may estimate and display to a patient not only the current wait times, but also the time the patient is expected to leave the doctor's office, or the like. In some embodiments, the system may be adapted to dynamically update the wait times of waiting patients based on data entered into the system, such as a number of scheduled appointments, an average time per type of appointment, an average wait time for each doctor, an average wait time per appointments scheduled in a day, an average wait time per day of the week, and or the like.

The system may adapt to store, maintain, and display a queue of all patients waiting to be seen. Each appointment may be associated appointment data, such as patient data, appointment types, appointment urgency, and/or wait times for each patient. In some embodiments, the queue may be automatically organized according to the appointment data, such that patients may be seen in the order they are listed and displayed in the queue. For example, if one patient has been waiting for two hours and a second patient has been waiting for twenty minutes, and each patient appointment comprises the same level of medical urgency, the patient waiting for two hours will be placed in a higher position on the queue, so that they may be seen before the patient waiting twenty minutes. In some embodiments, the urgency of the medical condition may be assigned a predetermined weight. For example, in an emergency room, or the like, if a patient has a condition that may be life-threatening or may cause serious medical harm if not treated immediately, that patient will be assigned the highest priority and will moved higher on the queue than patients with less serious conditions. For example, if a patient comes in with a life threatening condition, a doctor may be immediately notified of the condition, the patient may be placed first on the queue, and the expected wait times of all other patients may be dynamically updated by the system. Each patient waiting may then be notified via their computing device 120 that their wait time has increased.

In exemplary embodiments, the wait time indicator 122 may be displayed on a portion of the display 130, the majority of the display 130, and/or the entire display 130. In some embodiments, the wait time indicator 122 may be adapted to display different colors for a predetermined wait time. For example, if the wait time is expected or measured to be 10 minutes or less, the display 130 may display a green color; if the wait time is expected or measured to be 16-45 minutes, the display 130 may display a yellow color; if the wait time is expected or measured to be over 45 minutes, the display may display a red color, or the like. In some embodiments, an audible alarm may be generated by the client computer 120 when a wait time exceeds a predetermined threshold, for example, over one hour, or the like.

In some embodiments, when the wait time exceeds a predetermined threshold the system may be adapted to send a text message, or the like, to all scheduled patients for the remainder of the day notifying them of the expected wait time. For example, if the wait time is measured or estimated to be over 30 minutes, every patient scheduled to be seen may be sent a text message with the wait time by the system. In some embodiments, a separate physical display sign (not shown) communicatively coupled with the system, may be displayed in a prominent location in a waiting area of a healthcare provider. The display sign may be adapted to receive and display a wait time to all currently waiting patients and/or perform any of the functions of the client computer 120.

The system may also be adapted to dynamically reschedule and/or cancel appointments based on current wait time. For example, if an appointment wait time exceeds two hours, the system may automatically cancel an appointment and notify a patient that an appointment needs to be rescheduled. In some embodiments, a text message, email message, or the like, may be sent to patients notifying them of a canceled appointment. In some embodiments, when a measured or estimated wait time exceeds a predetermined or selected wait time, one or more patients may be sent a message asking the patient if they would wish to reschedule. One example message may read “Doctor Smith is delayed 30 minutes today due to emergency circumstances, would you like to reschedule your appointment?” If the patient indicates, via the client computer 120, that the patient wishes to reschedule, alternative appointment times may be sent to the patient and the patient may be provided the opportunity to make a new appointment via a scheduling interface 124. In some embodiments, a medical provider may have a kiosk on-site with access to a scheduling interface 124, so that patients without access to a personal client computer 120, or the like, may reschedule their appointment via the kiosk. In some embodiments, the wait time may be displayed via a widget on a client computer 120, or the like. In some embodiments, the system may automatically place a call to a stored contact telephone number for a patient if a wait time exceeds a predetermined threshold, and the patient may be offered the opportunity to reschedule by utilizing phone prompts, voice commands, and/or the like.

The client computer 120 may be adapted to display a scheduling interface 124, or the like. In exemplary embodiments, a scheduling interface 124 may be adapted to allow a patient to reschedule an appointment. For example, if the patient's appointment time has passed and they have not been seen by a doctor, the patient may wish to reschedule and/or cancel an appointment and may do so via the system. The scheduling interface 124 may allow a user to reschedule and/or cancel an appointment. The scheduling interface 124 may be communicatively coupled with a healthcare provider appointment database, or the like. In some embodiments, when an expected or measured wait time exceeds a predetermined threshold, the patient may be provided access to the scheduling interface 124. In some embodiments, if the system determines an appointment exists with a lower expected wait time than a patient is currently waiting, the system may be adapted to notify the patient currently waiting and provide them access to the scheduling interface to reschedule an the appointment to the time of the appointment with the lower expected wait time, or the like.

In some embodiments, the client computer 120 may be adapted to display an alternative activity interface 126. An alternative activity interface 126 may be adapted to notify a patient that alternative activities may exist that the patient may participate in while they are waiting. If a current wait time exceeds a predetermined amount, a patient may be provided with a list of activities appropriate with the current wait time. For example, if the current wait time is over 2 hours, the patient may be provided with a list of restaurants within walking distance or in close proximity to the healthcare provider facility. As such, a patent may be able to enjoy a meal, visit a coffee shop, a bookstore, a shopping merchant, a museum, and/or another activity of interest to the patient while waiting for their appointment, or the like. In some embodiments, the system may be adapted to generate coupons for the suggested activities. When the coupons are redeemed by patients at partner businesses, the healthcare provider may then be credited with a referral fee and the payment of the referral fee may be charged to the partner business by the system, or the like. In some embodiments a partner business may be charged a monthly advertising fee, or the like, to be listed as a recommended activity for waiting patients. The system may be adapted to keep records of and/or process payments of advertising fees from partner businesses.

In exemplary embodiments, a client computer 120 may be adapted to display an entertainment interface 128, or the like. In some embodiments, an entertainment interface 128 may be adapted to allow a user to access entertainment and/or educational content directly via the client computer 120. For example, the user may be provided access to play a game, to experience multimedia content, to watch a movie, to watch a television show, to read a book, to read a periodical, to read medical educational material, to view healthcare tips, and/or the like.

In some embodiments, the system may be adapted to present entertainment options to the user based on the expected wait time. For example, if the wait time is two hours, the entertainment interface 128 may be adapted to provide access to movies with run times under two hours, or the like. If the wait time is thirty minutes, the entertainment interface 128 may adapted to provide access to television shows with runtimes less than thirty minutes. In some embodiments, the entertainment interface may be adapted to collect payment for viewing certain entertainment or educational content. For example, the patient may be required to submit payment for all “new release” movies, or the like. In some embodiments, the entertainment interface 128 may provide content through a third party provider, and a portion of any fee collected may be divided among the healthcare provider and the third party content provider, or the like. In some embodiments, the system may be adapted to display third party advertisements from advertising sources. The system may be adapted to calculate and/or process payment to the healthcare provider and/or an administrator for advertising fees based on the number of patients that view an advertisement, or the like. In some embodiments, the system may be adapted to perform an analysis and generate reports on data stored within the system. For example, reports relating to overall average wait time per patient, average wait time per appointment type, average wait time per time period, average wait time per doctor, and/or the like may be generated by the system on demand or at predetermined intervals. For example, a daily report may be generated indicating the average wait times for each doctor, or the like.

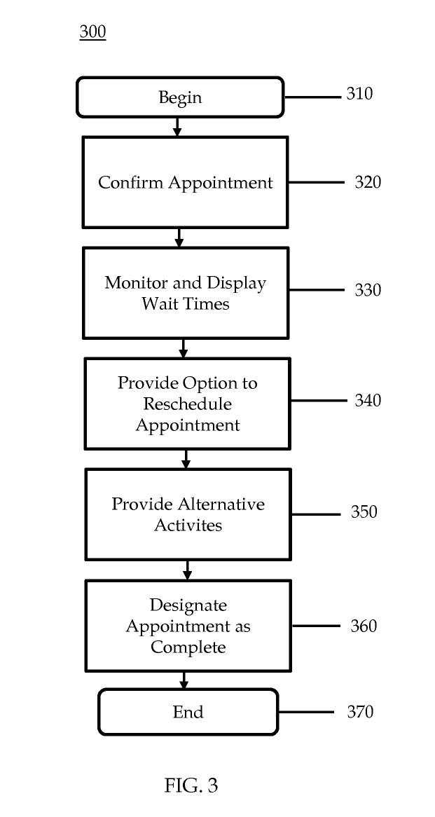

FIG. 3 depicts a flowchart of a method 300 of monitoring wait times in accordance with embodiments of the present invention. In some embodiments, the steps may be completed in different orders and/or some of the steps may be omitted. The method begins at step 310. For ease, the method 300 is described herein with reference to the system 100 and client computer 120 illustrated in FIGS. 1 and 2. At step 320, a client computer 120 is provided and a patient may be presented with the option of confirming an appointment. In some embodiments, an appointment may be marked as confirmed when the user sends a confirmation indication to the system and/or when the user checks-in via the system while at the location of the healthcare provider before an appointment. In alternative embodiments, an appointment may be canceled if a confirmation is not received from the patient. In some embodiments, after the appointment is confirmed, the system may be adapted to notify the patient of an expected wait time. In some embodiments, the system may be adapted to notify the patient of an expected wait time even if the patient does not check in. For example, the system may be adapted to notify the patient of an expected wait time the morning of an afternoon appointment, the day prior to an appointment, at a selected time interval before an appointment, and/or the like. The expected wait time may be calculated based on monitored and/or measured wait times of previous patents, and/or other factors as indicated supra. In some embodiments, if a wait time exceeds a predetermined threshold, the patient may be provided access to a scheduling interface 124.

At step 340, the patient interface may allow a patient to reschedule their appointment to a more convenient time or a time with a lower expected wait time. If the patient decides to wait for a scheduled appointment and/or the wait time is below a predetermined threshold, the patient may be provided access to an alternative activity interface 126. The alternative activity interface may display alternative activities the user may participate in during the current wait time indicated by the system. If the user wishes to stay in the healthcare provider facility while waiting to be seen, or if the user wishes to leave the facility but does not wish to participate in any alternative activity suggested by the system, the user may access entertainment and/or educational content via an entertainment interface 128.

In exemplary embodiments, the system may present all available activity and/or entertainment options to the user independent of wait time, or the system may present a list of activities and/or entertainment options based on the current wait time. In some embodiments, the user may filter the available activities and/or entertainment options based on a wait time, or the like. After the patient is seen by the doctor, the system may indicate that the patient has been seen and the wait time may be dynamically updated accordingly. When an appointment has completed and a patient leaves the healthcare provider facility, the appointment may be marked as complete via the system and the method ends at step 370.

In some embodiments of the present disclosure, the systems disclosed herein may be used to track patients and/or customers. The system may be adapted to collect data and track the timeliness of patients and perform analysis on the collected data to optimize the schedule of the doctor, or the like, thereby also optimizing profitability of the practice. By way of example, the timeliness of a patient may be tracked by the system over several visits and saved by the system in memory. After a predetermined number of visits, the patient's timeliness data may be analyzed.

In some embodiments, the system may calculate an anticipated arrival time for a patient based on their past behavior and notify a user of the system, such as an administrator, or the like. The user may then schedule the patient in an appointment timeslot that optimizes the patient's typical behavior. For example, if a patient is habitually 20 minutes late to appointments, the system may notify a user and the user may schedule the patient on a date and at a time that is anticipated to be less busy than average so that the doctor's entire schedule does not have to be rearranged and/or appointments canceled if the patient shows up 20 minutes late for their next appointment during a busy time.

In some embodiments, the system may be adapted to calculate an anticipated arrival time or an anticipated amount of time the user will be late based on an analysis of the timeliness data. In some embodiments, statistical outliers, or the like may be eliminated when making this calculation. For example, if a user is late by 5 minutes or less for 20 appointments and on one appointment they are 45 minutes late, the appointment when the user was 45 minutes late may be marked as an outlier and ignored in statistical calculations. Any statistical calculation method suitable for embodiments of the present disclosure may be used in making a calculation of a patient's anticipated arrival time or anticipated amount of minutes late.

In another example, if two example patients need to be scheduled—Patient A and Patient B, the user may choose to schedule each patient based on their average and/or anticipated arrival time. If a typical appointment lasts 30 minutes and Patient A is typically on-time and Patient B is typically 30 minutes late, the user may choose to schedule both patients at the same time so that the doctor can meet with Patient A first and Patient B when they show up 30 minutes late and after Patient A's appointment is complete. In some embodiments, the patient timeliness data may be analyzed and presented to a user and the user may make the scheduling decision based on the collected data. In some embodiments, the system may automatically optimize the schedule and suggest appointment times for the patent based on their tracked timeliness data dynamically, taking into account the other appointments scheduled on the system and the typical number of appointments scheduled on that date based on historical data, or the like.

The patient's arrival time may be tracked manually by a user when the patient arrives and checks in, or may be automated or preformed by the system. In some embodiments, the system may track the location of the user's mobile device, or the like and may automatically check the user in and count them as arrived when they are in a predetermined proximity to the office or the like. In some embodiments, the system may present a push notification to the patient's mobile device allowing the user to check in to the office and verify that they have arrived for their appointment when they are in proximity to the office.

In some embodiments, when the patient is “checked in”, or an indication is received by the system that the patient has arrived for their appointment, the system may compare the arrival time to the scheduled appointment time and record the difference in the two times. This timeliness data may be saved in data and associated with the patient's user account. In some embodiments, if the user is late, they may be provided the opportunity to enter a reason for the tardiness that may be saved by the system and associated with the tracked timeliness data, or the like. In some embodiments, when a statistically insignificant amount of data has been collected for a patient or if a patient is new to a practice, the system may assign the average tardiness time of all patients at that practice, in that geographic area, or all patients nationally to that patient until enough data is collected to calculate and assign an anticipated amount of time the patient will be late, or the like.

While the foregoing is directed to embodiments of the present invention, other and further embodiments of the invention may be devised without departing from the basic scope thereof. For example, although numerous embodiments having various features have been described herein, combinations of such various features in other combinations not discussed herein are contemplated within the scope of embodiments of the present invention.

What is claimed is:

1. A computer-implemented method for optimizing customer scheduling, the method comprising:
at a server having one or more processors and memory storing one or more programs for execution by the one or more processors:
receiving a request to create a customer account for a customer;
creating the customer account for the customer;
receiving a request to make an appointment for the customer, scheduling an appointment time for the customer, and recording the appointment time;
recording an arrival time for the customer when the customer arrives for their appointment and calculating the amount of time the customer is tardy based on the appointment time;
associating the amount of time the customer is tardy with the user account for the customer and saving it in memory as tardiness data;
generating an anticipated amount of time the customer will arrive after their appointment time for a next appointment based on the tardiness data;
receiving a request to make a second appointment for the customer, and notifying a user of the anticipated amount of time the customer will arrive after their appointment time; and
scheduling the second appointment time for the customer and recording the appointment time.
